(19) United States
(12) Patent Application Publication
(10) Pub. No.: US 2025/0063517 A1
(43) Pub. Date: Feb. 20, 2025

(54) POWER CONFIGURATION METHOD FOR TERMINAL, APPARATUS, COMMUNICATION DEVICE, AND STORAGE MEDIUM

(71) Applicant: Beijing Xiaomi Mobile Software Co., Ltd., Beijing (CN)

(72) Inventor: Rui ZHOU, Beijing (CN)

(73) Assignee: Beijing Xiaomi Mobile Software Co., Ltd., Beijing (CN)

(21) Appl. No.: 18/722,017

(22) PCT Filed: Dec. 31, 2021
(86) PCT No.: PCT/CN2021/143891

§ 371 Date: Jun. 20, 2024

(51) Int. Cl. H04W 52/28

(52) U.S. Cl. CPC H04W 52/288

(57) ABSTRACT

Provided in an embodiment of the present disclosure is a power configuration method for a terminal. The method is executed by a network device and includes: determining a power parameter for a terminal to transmit a predetermined service according to an operational state that the terminal is in, wherein the predetermined service comprises a new radio (NR) service and/or an NR sidelink (SL) service, and the operational state comprises one of the following: a first operational state indicating a state where the terminal transmits the NR SL service on a shared spectrum, and a second operational state indicating a state where the terminal transmits the NR service and the NR SL service on a shared spectrum.

### CROSS-REFERENCE TO RELATED APPLICATIONS

The present application is a U.S. National Stage of International Application No. PCT/CN2021/143891, filed on Dec. 31, 2021, the contents of which are incorporated herein by reference in its entirety for all purposes.

### TECHNICAL FIELD

The present disclosure relates to, but is not limited to, the field of wireless communication technologies, and in particular to a method and apparatus for configuring a power of a terminal, a communication device and a storage medium.

### BACKGROUND

Vehicle to Everything (V2X) is a new generation of information and communication technologies that connect vehicles to everything. V2X can provide two communication interfaces, which are referred to as the Uu interface and the PC5 interface, respectively. In wireless communications, demands for operator-based spectrums are increasing, but actual spectrums that can be allocated for use are gradually decreasing. In V2X scenarios, for operators' existing licensed frequency bands, it is a major demand for the operators to concurrently transmit New Radio (NR) shared spectrum services and NR V2X services on shared spectrums. For terminals, it will be a common scenario to concurrently transmit NR services and NR Sidelink services on the same licensed frequency band.

### SUMMARY

Embodiments of the present disclosure provide a method and apparatus for configuring a power of a terminal, a communication device and a storage medium.

According to a first aspect of embodiments of the present disclosure, there is provided a method for configuring a power of a terminal, wherein the method is performed by a network device, and includes:
determining, according to a working state of the terminal, a power parameter for the terminal to transmit a predetermined service;
wherein the predetermined service includes: a New Radio (NR) service and/or an NR Sidelink (SL) service; and the working state includes one of:
a first working state indicating a state in which the NR SL service is transmitted by the terminal on a shared spectrum; or
a second working state indicating a state in which the NR service and the NR SL service are transmitted by the terminal on the shared spectrum.

According to a second aspect of embodiments of the present disclosure, there is provided a method for configuring a power of a terminal, wherein the method is performed by the terminal, and includes:
receiving power configuration information for transmitting a predetermined service, wherein the predetermined service includes: a NR service and/or a NR SL service, and the power configuration information indicates a power parameter; and
transmitting the NR service and/or the NR SL service based on the power parameter.

According to a third aspect of embodiments of the present disclosure, there is provided a communication device, including:
a processor; and
a memory configured to store executable instructions of the processor;
wherein the processor is configured to implement the method described in any embodiment of the present disclosure when running the executable instructions.

According to a fourth aspect of embodiments of the present disclosure, there is provided a computer storage medium having a computer executable program stored thereon, which, when executed by a processor, implement the method described in any embodiment of the present disclosure.

It should be noted that the above general description and the following detailed description are merely exemplary and explanatory and should not be construed as limiting of the disclosure.

### BRIEF DESCRIPTION OF THE DRAWINGS

The accompanying drawings, which are incorporated in and constitute a part of this specification, illustrate embodiments consistent with the present disclosure and, together with the description, serve to explain principles of the present disclosure.

FIG. 1 shows a schematic structural diagram of a wireless communication system according to an embodiment of the present disclosure.

FIG. 2 shows a schematic flowchart of a method for configuring a power of a terminal according to an embodiment of the present disclosure.

FIG. 3 shows a schematic flowchart of a method for configuring a power of a terminal according to an embodiment of the present disclosure.

FIG. 4 shows a schematic flowchart of a method for configuring a power of a terminal according to an embodiment of the present disclosure.

FIG. 5 shows a schematic flowchart of a method for configuring a power of a terminal according to an embodiment of the present disclosure.

FIG. 6 shows a schematic flowchart of a method for configuring a power of a terminal according to an embodiment of the present disclosure.

FIG. 7 shows a schematic flowchart of a method for configuring a power of a terminal according to an embodiment of the present disclosure.

FIG. 8 shows a schematic structural diagram of an apparatus for configuring a power of a terminal according to an embodiment of the present disclosure.

FIG. 9 shows a schematic structural diagram of an apparatus for configuring a power of a terminal according to an embodiment of the present disclosure.

FIG. 10 shows a schematic structural diagram of a terminal according to an embodiment of the present disclosure.

FIG. 11 shows a block diagram of a base station according to an embodiment of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of the embodiments do not represent all implementations consistent with the present disclosure. Instead, they are merely examples of apparatuses and methods consistent with some aspects of the embodiments of the present disclosure as recited in the appended claims.

The terms used in the embodiments of the present disclosure are merely for the purpose of describing particular embodiments and are not intended to limit the embodiments of the present disclosure. As used in the embodiments of the present disclosure and the appended claims, the singular forms “a” and “the” are intended to include the plural forms as well, unless the context clearly indicates otherwise. It should also be understood that the term “and/or” as used herein refers to and includes any or all possible combinations of one or more of the associated listed items.

It should be understood that, although the terms first, second, third, etc. may be used in embodiments of the present disclosure to describe various information, such information should not be limited to these terms. These terms are only used to distinguish the same type of information from each other. For example, without departing from the scope of embodiments of the present disclosure, first information may also be referred to as second information, and similarly, the second information may also be referred to as the first information. Depending on the context, the word “if” as used herein can be interpreted as “upon” or “when” or “in response to determination”.

For the purpose of brevity and ease of understanding, the term “greater than” or “less than” is used herein to describe magnitude relationships. However, those skilled in the art can understand that the term “greater than” also covers the meaning of “greater than or equal to”, and “less than” also covers the meaning of “less than or equal to”.

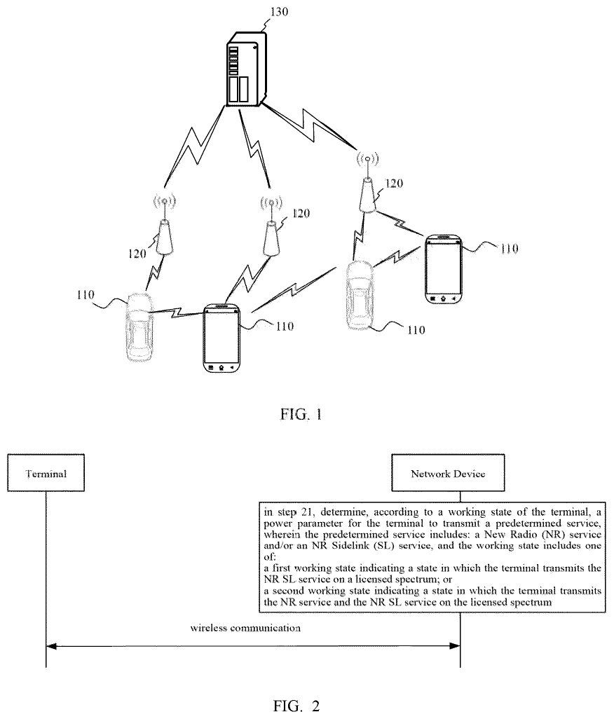

Reference is made to FIG. 1, which shows a schematic structural diagram of a wireless communication system provided by an embodiment of the present disclosure. As illustrated in FIG. 1, the wireless communication system is a communication system based on cellar mobile communication technologies. The wireless communication system may include several user equipment 110 and several base stations 120.

The user equipment 110 may refer to a device that provides voice and/or data connectivity to a user. The user equipment 110 may communicate with one or more core networks via a Radio Access Network (RAN). The user equipment 110 may be an Internet of Things user device, such as a sensor device, a mobile phone (or caller “cellular” phone) and a computer with the Internet of Things user device, for example, may be a fixed, portable, pocket-sized, handheld, built-in computer or vehicle-mounted device. For example, the user equipment may be a station (STA), a subscriber unit, a subscriber station, a mobile station, a mobile, a remote station, an access point, a remote terminal, an access terminal, a user terminal, a user agent, a user device, or user equipment. Or, the user equipment 110 may also be a device of an unmanned aerial vehicle. Or, the user equipment 110 may also be a vehicle-mounted device, such as a trip computer with a wireless communication function, or a wireless user device connected to an external trip computer. Or, the user equipment 110 may also be a roadside device, such as a streetlight, a signal light or another roadside device with a wireless communication function.

The base station 120 can be a network-side device in a wireless communication system. The wireless communication system can be a 4th generation mobile communication (4G) system, also known as a Long Term Evolution (LTE) system. Or, the wireless communication system may also be a 5G system, also known as a New Radio (NR) system or a 5G NR system. Or, the wireless communication system may also be a next-generation system of 5G system. An access network in the 5G system can be referred to as a New Generation-Radio Access Network (NG-RAN).

The base station 120 can be an evolved NodeB (eNB) in the 4G system. Or, the base station 120 may also be a gNB with a central distributed architecture in the 5G system. When the base station 120 adopts the central distributed architecture, it usually includes a Central Unit (CU) and at least two Distributed Units (DUs). The CU is provided with a protocol stack of a Packet Data Convergence Protocol (PDCP) layer, a Radio Link Control (RLC) layer, and a Media Access Control (MAC) layer. The DU is provided with a protocol stack of a Physical (PHY) layer. A specific implementation of the base station 120 is not limited in embodiments of the present disclosure.

A wireless connection can be established between the base station 120 and the user equipment 110 through a radio air interface. In different implementations, the radio air interface is a radio air interface based on a 4th generation mobile communication network technology (4G) standard. Or, the radio air interface is a radio air interface based on a 5th generation mobile communication network technology (5G) standard, such as the NR. Or, the radio air interface may also be a radio air interface based on a 5G next-generation mobile communication network technology standard.

In some embodiments, an End to End (E2E) connection may also be established between the user equipment 110, such as a vehicle to vehicle (V2V) communication, a vehicle to infrastructure (V2I) communication and a vehicle to pedestrian (V2P) communication in a vehicle to everything (V2X) communication, and other scenarios.

Here, the above-mentioned user equipment may be considered as a terminal device in the following embodiments.

In some embodiments, the above wireless communication system may further include a network management device 130.

The several base stations 120 are connected to the network management device 130, respectively. The network management device 130 can be a core network device in the wireless communication system. For example, the network management device 130 can be a Mobility Management Entity (MME) in an Evolved Packet Core (EPC) network. Or, the network management device may also be another core network device, such as a Serving Gateway (SGW), a Public Data Network Gateway (PGW), a Policy and Charging Rules Function (PCRF) unit or a Home Subscriber Server (HSS). An implementation form of the network management device 130 is not limited in embodiments of the present disclosure.

In order to facilitate the understanding of those skilled in the art, embodiments of the present disclosure exemplify a plurality of implementations to clearly illustrate technical solutions of the embodiments of the present disclosure. In addition, those skilled in the art can understand that a plurality of embodiments provided by the embodiments of the present disclosure can be executed alone, or can be executed together with methods of other embodiments of the embodiments of the present disclosure, or can be executed together with some methods in other related arts alone or in combination, which is not limited in the embodiments of the present disclosure.

In order to better understand the technical solution described in any embodiment of the present disclosure, an application scenario of the power configuration in the related art is illustrated first.

In a scenario embodiment, in a NR Sidelink configuration, a network configures, by means of configuration and pre-configuration methods, a power of a terminal in Sidelink through a Radio Resource Control (RRC) signaling (e.g., sl-TxPower), and the network configures, on a NR shared spectrum, the maximum power that the terminal in the cell can transmit by configuring the RRC signaling (e.g., p-max). However, when the terminal works on the shared spectrum and transmits a NR Sidelink service, there is a situation where sl-TxPower and p-max are inconsistent, and in this case, a terminal configuration needs to be clarified.

In addition, if the terminal concurrently transmits the NR service and the NR Sidelink service on the shared spectrum, it is necessary to constrain the terminal power according to specific multiplexing modes (that is, a Frequency Division Multiplexing (FDM) mode or a Time Division Multiplexing (TDM) mode) of these two services, so as to ensure that the terminal power is controlled within an appropriate range to avoid interference with other communication transmissions in the cell.

In the related arts, power configuration manners used by the terminal for the NR service and the NR Sidelink service are inconsistent, resulting in that after the terminal accesses the cell, there are two different power configuration signalings when the terminal performs the NR Sidelink service on the licensed frequency band, which easily causes confusion. In addition, if the terminal concurrently performs the NR service and the NR Sidelink service on the shared spectrum, the power configuration of the terminal is also unclear at present. The present invention clarifies the power configuration for the above two situations to prevent from configuring too high power for the terminal in the cell to cause interference to other communications in the cell, or configuring too low power for the terminal in the cell to cause the performance degradation and reduced network coverage.

As shown in FIG. 2, an embodiment of the present disclosure provides a method for configuring a power of a terminal. The method is performed by a network device, and includes:

in step 21, a power parameter for the terminal to transmit a predetermined service is determined according to a working state of the terminal;

the predetermined service includes: a New Radio (NR) service and/or an NR Sidelink (SL) service, and the working state includes one of:

a first working state indicating a state in which the terminal transmits the NR SL service on a shared spectrum; or

a second working state indicating a state in which the terminal transmits the NR service and the NR SL service on the shared spectrum.

Here, the terminal involved in the present disclosure may be but is not limited to a mobile phone, a wearable device, a vehicle-mounted terminal, a Road Side Unit (RSU), a smart home terminal, an industrial sensor device and/or a medical device, etc.

The network device involved in the present disclosure may be an access device for the terminal to access a network. Here, the network device may be various types of base stations, for example, a base station of a third generation mobile communication (3G) network, a base station of a fourth generation mobile communication (4G) network, a base station of a fifth generation mobile communication (5G) network, or other evolved base stations. It should be noted that the network device in the present disclosure is not limited to the base station in the access network, but may also be a communication node in a core network, which is not limited here. For example, determination and/or configuration operations in the present disclosure may also be performed by a network device in the core network.

In an embodiment of the present disclosure, the terminal may transmit the NR service and/or the NR SL service on the same licensed frequency band. For example, the terminal may transmit the NR service on the Uu interface, and the terminal may transmit the NR SL service on the PC5 interface.

It should be noted that the second working state may indicate the state in which the terminal concurrently transmits the NR service and the NR SL service on the shared spectrum. Here, the concurrent transmission of the NR service and the NR SL service may be the transmission of the NR service and the NR SL service on the same licensed frequency band in a frequency division mode or in a time division mode.

In an embodiment of the present disclosure, the network device determines, according to the working state of the terminal, the power parameter for the terminal to transmit the predetermined service, and sends power configuration information to the terminal, the power configuration information indicates the power parameter. Once receiving the power configuration information, the terminal can perform the NR service and/or the NR SL service based on the power parameter. Here, the power parameter may be a parameter indicating the maximum transmission power.

In an embodiment of the present disclosure, the network device sends to the terminal indication information indicating the working state. After receiving the indication information, the terminal transmits the NR service and/or the NR SL service based on the working state indicated by the indication information. The network device determines, according to the working state indicated by the indication information, the power parameter for the terminal to transmit the predetermined service. Here, the network device may send to the terminal the indication information indicating the working state through an RRC message.

In an embodiment of the present disclosure, the network device receives the indication information indicating the working state sent by the terminal, and the network device determines, according to the working state indicated by the indication information, the power parameter for the terminal to transmit the predetermined service. Here, the network device may receive, through the RRC message, the indication information indicating the working state sent by the terminal.

In an embodiment of the present disclosure, before sending the power configuration information to the terminal, the network device will configure a first parameter for the terminal, and the first parameter is a power for the terminal to transmit the NR SL service; the network device also configures a second parameter for the terminal, and the second parameter is the maximum transmit power of the terminal when transmitting the NR service in the cell. Here, the first parameter may be sl-TxPower, and the second parameter may be p-max.

In an embodiment of the present disclosure, the working state of the terminal is determined. If the working state of the terminal is determined to be the first working state, a smaller parameter among the first parameter and the second parameter is determined to be the power parameter. For example, if the first parameter is greater than the second parameter, the second parameter is determined to be the power parameter; or, if the first parameter is less than the second parameter, the first parameter is determined to be the power parameter. After the power parameter is determined, the network device sends the power configuration information to the terminal, and the power configuration information indicates the power parameter. It should be noted that the first working state may be a state in which the terminal transmits the NR SL service on the shared spectrum without transmitting the NR service on this shared spectrum. Here, the terminal may perform a single-carrier NR SL service transmission on the shared spectrum.

In an embodiment of the present disclosure, the working state of the terminal is determined. If the working state of the terminal is determined to be the first working state, the power parameter is determined to be the first parameter. After the power parameter is determined, the network device sends the power configuration information to the terminal, and the power configuration information indicates the power parameter.

In an embodiment of the present disclosure, after receiving the power configuration information, the terminal ignores the first parameter and the second parameter.

In an embodiment of the present disclosure, the working state of the terminal is determined. If the working state of the terminal is determined to be the second working state, it is necessary to determine a mode in which the terminal transmits the NR service and the NR SL service. According to the determined mode in which the terminal transmits the NR service and the NR SL service, the power parameter for the terminal to transmit the predetermined service is determined. It should be noted that the terminal may transmit the NR service and the NR SL service in a Time Division Multiplexing (TDM) mode, and the terminal may also transmit the NR service and the NR SL service in an FDM mode.

In an embodiment of the present disclosure, if it is determined that the working state of the terminal is the second working state and it is determined that the terminal transmits the NR service and the NR SL service in the Time Division Multiplexing (TDM) mode, the power parameter for transmitting the NR service is determined to be the second parameter and/or the power parameter for transmitting the NR SL service is determined to be a smaller parameter among configured parameters.

In an embodiment of the present disclosure, if it is determined that the working state of the terminal is the second working state and it is determined that the terminal transmits the NR service and the NR SL service in the Frequency Division Multiplexing (FDM) mode, the power parameter for transmitting the NR service is determined to be a third parameter and/or the power parameter for transmitting the NR SL service is determined to be a fourth parameter, and the sum of the third parameter and the fourth parameter is less than the second parameter. Here, the third parameter may be P_{NR}, the fourth parameter may be P_{NR_SL}, and the second parameter may be p-max. It should be noted that in the present disclosure, “less than” has the meaning of “less than or equal to”. It should be noted that here, the terminal transmits the NR service and the NR SL service on different carrier frequencies of the shared spectrum, respectively within the same time.

In an embodiment of the present disclosure, before sending to the terminal the power configuration information for transmitting the predetermined service, the network device will configure a time-frequency domain resource for the terminal according to a service type indicated for the terminal to transmit, and the time-frequency domain resource includes a time domain resource and/or a frequency domain resource. For example, if the service type indicated for the terminal to transmit is the NR SL service, a first time-frequency domain resource will be configured for the terminal; or if the service type indicated for the terminal to transmit is the NR service and the NR SL service, a second time-frequency domain resource for the NR service and a third time-frequency domain resource for the NR SL service will be configured for the terminal. In this way, the working state of the terminal can be determined based on the time-frequency domain resource configured for the terminal. For example, if the time-frequency domain resource configured for the terminal is the first time-frequency domain resource, the working state of the terminal is determined to be the first working state; or, if the time-frequency domain resource configured for the terminal is the second time-frequency domain resource and the third time-frequency domain resource, the working state of the terminal is determined to be the second working state.

In embodiments of the present disclosure, the power parameter for the terminal to transmit the service is determined according to the working state of the terminal, the working state includes at least one of: the first working state indicating the state in which the terminal transmits the NR SL service on the shared spectrum; or the second working state indicating the state in which the terminal transmits the NR service and the NR SL service on the shared spectrum. In this way, since the power parameter for the terminal to transmit the service is determined according to the working state of the terminal, different power parameters can be configured for different working states, and the power parameters will be quite clear. Compared with a situation where the use of the power parameter is unclear when the terminal is in different working states, the power parameters used in different working states can be clarified for the terminal. As such, the interference between the signals can be reduced, and the transmission performance of the terminal and the network communication coverage capability can be improved.

It should be noted that those skilled in the art can understand that the method provided in embodiments of the present disclosure can be executed alone or in combination with some methods in the embodiments of the present disclosure or some methods in the related arts.

As shown in FIG. 3, an embodiment of the present disclosure provides a method for configuring a power of a terminal. The method is performed by the network device, and includes:
in step 31, according to a working state of a terminal, a power parameter is determined based on a configured parameter; and
the configured parameter includes at least one of:
a first parameter, which is a power for the terminal to transmit a NR SL service; or
a second parameter, which is the maximum transmit power of the terminal when transmitting a NR service in a cell.

In an embodiment of the present disclosure, according to the working state of the terminal, the power parameter is determined based on the configured parameter, and power configuration information is sent to the terminal, the power configuration information indicates the power parameter. Once receiving the power configuration information, the terminal can perform the NR service and/or the NR SL service based on the power parameter. Here, the power parameter may be a parameter indicating the maximum transmission power.

In an embodiment of the present disclosure, before sending the power configuration information to the terminal, the network device will configure a first parameter for the terminal, and the first parameter is a power for the terminal to transmit the NR SL service; the network device also configures a second parameter for the terminal, and the second parameter is the maximum transmit power when the terminal transmits the NR service in the cell. Here, the first parameter may be sl-TxPower, and the second parameter may be p-max. It should be noted that after configuring the first parameter and the second parameter, the network device may send the first parameter and the second parameter to the terminal through an RRC message.

In an embodiment of the present disclosure, after receiving the power configuration information, the terminal ignores the first parameter and the second parameter.

In an embodiment of the present disclosure, the working state of the terminal is determined. If the working state of the terminal is determined to be the first working state, a smaller parameter among the first parameter and the second parameter is determined to be the power parameter. For example, if the first parameter is greater than the second parameter, the second parameter is determined to be the power parameter; or, if the first parameter is less than the second parameter, the first parameter is determined to be the power parameter. After the power parameter is determined, the network device sends the power configuration information to the terminal, and the power configuration information indicates the power parameter. It should be noted that the first working state may be a state in which the terminal transmits the NR SL service on the shared spectrum without transmitting the NR service on this shared spectrum. Here, the terminal may perform a single-carrier NR SL service transmission on the shared spectrum.

In an embodiment of the present disclosure, if it is determined that the working state of the terminal is the second working state and it is determined that the terminal transmits the NR service and the NR SL service in the Time Division Multiplexing (TDM) mode, the power parameter for transmitting the NR service is determined to be the second parameter and/or the power parameter for transmitting the NR SL service is determined to be a smaller parameter among configured parameters.

In an embodiment of the present disclosure, if it is determined that the working state of the terminal is the second working state and it is determined that the terminal transmits the NR service and the NR SL service in the Frequency Division Multiplexing (FDM) mode, the power parameter for transmitting the NR service is determined to be a third parameter and/or the power parameter for transmitting the NR SL service is determined to be a fourth parameter, and the sum of the third parameter and the fourth parameter is less than the second parameter. Here, the third parameter may be P_{NR}, the fourth parameter may be P_{NR_SL}, and the second parameter may be p-max. It should be noted that in the present disclosure, “less than” has the meaning of “less than or equal to”. It should be noted that here, the terminal transmits the NR service and the NR SL service on different carrier frequencies of the shared spectrum, respectively within the same time.

It should be noted that those skilled in the art can understand that the method provided in embodiments of the present disclosure can be executed alone or in combination with some methods in the embodiments of the present disclosure or some methods in the related arts.

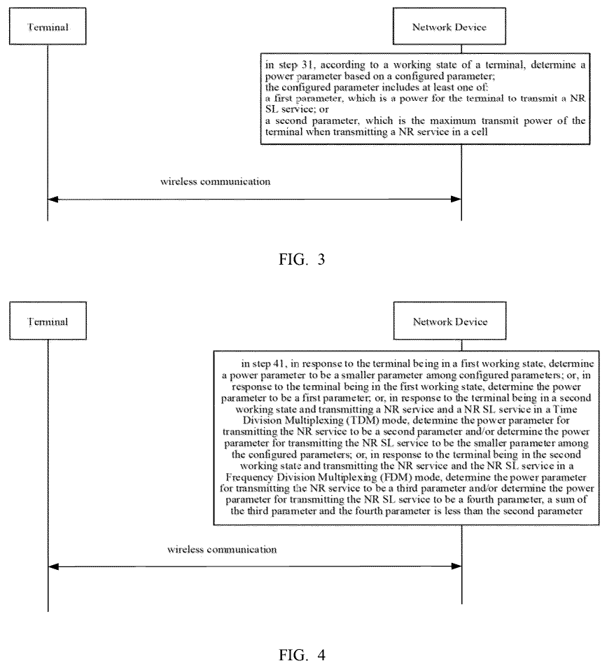

As shown in FIG. 4, an embodiment of the present disclosure provides a method for configuring a power of a terminal. The method is performed by the network device, and includes:
in step 41, in response to the terminal being in a first working state, a power parameter is determined to be a smaller parameter among configured parameters; or, in response to the terminal being in the first working state, the power parameter is determined to be a first parameter; or, in response to the terminal being in a second working state and transmitting a NR service and a NR SL service in a Time Division Multiplexing (TDM) mode, the power parameter for transmitting the NR service is determined to be a second parameter and/or the power parameter for transmitting the NR SL service is determined to be the smaller parameter among the configured parameters; or, in response to the terminal being in the second working state and transmitting the NR service and the NR SL service in a Frequency Division Multiplexing (FDM) mode, the power parameter for transmitting the NR service is determined to be a third parameter and/or the power parameter for transmitting the NR SL service is determined to be a fourth parameter, a sum of the third parameter and the fourth parameter is less than the second parameter.

In an embodiment of the present disclosure, the configured parameter includes at least one of:
a first parameter, which is a power for the terminal to transmit a NR SL service; or
a second parameter, which is the maximum transmit power of the terminal when transmitting a NR service in a cell.

Here, the first parameter may be sl-TxPower, the second parameter may be p-max, the third parameter may be P_{NR}, and the fourth parameter may be P_{NR_SL}.

For a specific implementation of the step 41, reference may be made to the description of the step 31, which will not be repeated here.

Here, in response to the terminal being in the first working state, the power parameter is determined to be the smaller parameter among the configured parameters. In this way, since the power parameter is the smaller parameter among the configured parameters, the power consumption can be saved and the endurance of the terminal can be improved.

Here, in response to the terminal being in the second working state and transmitting the NR service and the NR SL service in the Time Division Multiplexing (TDM) mode, the power parameter for transmitting the NR service is determined to be the second parameter and/or the power parameter for transmitting the NR SL service is determined to be the smaller parameter among the configured parameters. In this way, since the time division multiplexing mode is used for transmission, different power parameters can be flexibly selected, making the configuration of the power parameter more flexible.

Here, in response to the terminal being in the second working state and transmitting the NR service and the NR SL service in the Frequency Division Multiplexing (FDM) mode, the power parameter for transmitting the NR service is determined to be the third parameter and/or the power parameter for transmitting the NR SL service is determined to be the fourth parameter, the sum of the third parameter and the fourth parameter is less than the second parameter. In this way, since the frequency division multiplexing mode is used for transmission, it is ensured that the sum of the third parameter and the fourth parameter is less than the second parameter, so that the transmission power of the terminal does not exceed the maximum of the terminal power, thereby ensuring the reliability of the communication.

It should be noted that those skilled in the art can understand that the method provided in embodiments of the present disclosure can be executed alone or in combination with some methods in the embodiments of the present disclosure or some methods in the related arts.

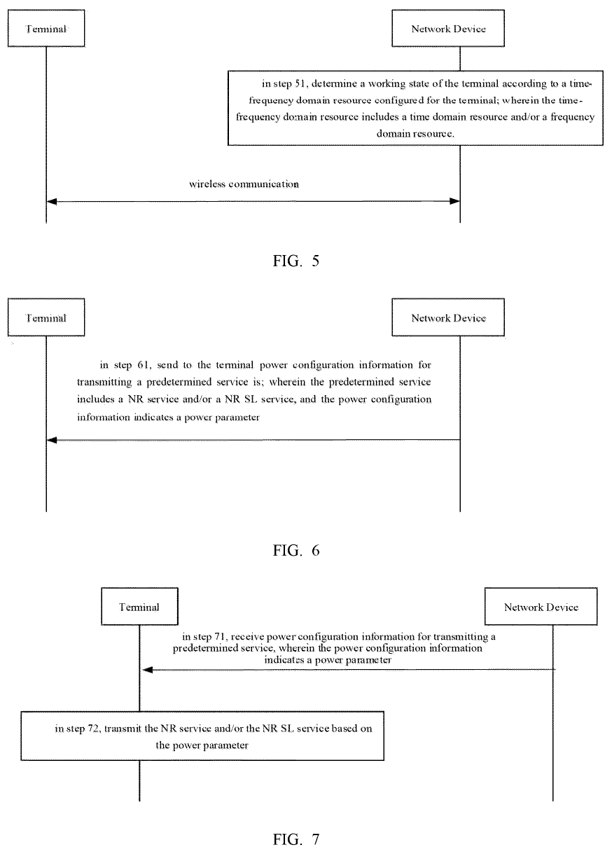

As shown in FIG. 5, an embodiment of the present disclosure provides a method for configuring a power of a terminal. The method is performed by the network device, and includes:
in step 51, a working state of the terminal is determined according to a time-frequency domain resource configured for the terminal; and
the time-frequency domain resource includes a time domain resource and/or a frequency domain resource.

In an embodiment of the present disclosure, the working state of the terminal is determined according to the time-frequency domain resource configured for the terminal. The network device determines, according to the working state of the terminal, a power parameter for the terminal to transmit a predetermined service, and sends power configuration information to the terminal, the power configuration information indicates the power parameter. Once receiving the power configuration information, the terminal can perform the NR service and/or the NR SL service based on the power parameter. Here, the power parameter may be a parameter indicating the maximum transmission power.

In an embodiment of the present disclosure, before sending to the terminal the power configuration information for transmitting the predetermined service, the network device will configure a time-frequency domain resource for the terminal according to a service type indicated for the terminal to transmit, and the time-frequency domain resource includes a time domain resource and/or a frequency domain resource. For example, if the service type indicated for the terminal to transmit is the NR SL service, a first time-frequency domain resource will be configured for the terminal; or if the service type indicated for the terminal to transmit is the NR service and the NR SL service, a second time-frequency domain resource for the NR service and a third time-frequency domain resource for the NR SL service will be configured for the terminal. In this way, the working state of the terminal can be determined based on the time-frequency domain resource configured for the terminal. For example, if the time-frequency domain resource configured for the terminal is the first time-frequency domain resource, the working state of the terminal is determined to be the first working state; or, if the time-frequency domain resource configured for the terminal is the second time-frequency domain resource and the third time-frequency domain resource, the working state of the terminal is determined to be the second working state.

It should be noted that those skilled in the art can understand that the method provided in embodiments of the present disclosure can be executed alone or in combination with some methods in the embodiments of the present disclosure or some methods in the related arts.

As shown in FIG. 6, an embodiment of the present disclosure provides a method for configuring a power of a terminal. The method is performed by the network device, and includes:
in step 61, power configuration information for transmitting a predetermined service is sent to the terminal; and
the predetermined service includes a NR service and/or a NR SL service, and the power configuration information indicates a power parameter.

In an embodiment of the present disclosure, the network device determines, according to the working state of the terminal, the power parameter for the terminal to transmit the predetermined service, and sends power configuration information to the terminal, the power configuration information indicates the power parameter. Once receiving the power configuration information, the terminal can perform the NR service and/or the NR SL service based on the power parameter. Here, the power parameter may be a parameter indicating the maximum transmission power.

It should be noted that those skilled in the art can understand that the method provided in embodiments of the present disclosure can be executed alone or in combination with some methods in the embodiments of the present disclosure or some methods in the related arts.

As shown in FIG. 7, an embodiment of the present disclosure provides a method for configuring a power of a terminal. The method is performed by the terminal, and includes:
in step 71, power configuration information for transmitting a predetermined service is received, the predetermined service includes a NR service and/or a NR SL service, and the power configuration information indicates a power parameter; and
in step 72, the NR service and/or the NR SL service are transmitted based on the power parameter.

Here, the terminal involved in the present disclosure may be but is not limited to a mobile phone, a wearable device, a vehicle-mounted terminal, a Road Side Unit (RSU), a smart home terminal, an industrial sensor device and/or a medical device, etc.

The network device involved in the present disclosure may be an access device for the terminal to access a network. Here, the network device may be various types of base stations, for example, a base station of a third generation mobile communication (3G) network, a base station of a fourth generation mobile communication (4G) network, a base station of a fifth generation mobile communication (5G) network, or other evolved base stations. It should be noted that the network device in the present disclosure is not limited to the base station in the access network, but may also be a communication node in a core network, which is not limited here. For example, determination and/or configuration operations in the present disclosure may also be performed by a network device in the core network.

In an embodiment of the present disclosure, the terminal may transmit the NR service and/or the NR SL service on the same licensed frequency band. For example, the terminal may transmit the NR service on the Uu interface, and the terminal may transmit the NR SL service on the PC5 interface.

It should be noted that the second working state may indicate the state in which the terminal concurrently transmits the NR service and the NR SL service on the shared spectrum. Here, the concurrent transmission of the NR service and the NR SL service may be the transmission of the NR service and the NR SL service on the same licensed frequency band in a frequency division mode or in a time division mode.

In an embodiment of the present disclosure, the network device determines, according to the working state of the terminal, the power parameter for the terminal to transmit the predetermined service, and sends power configuration information to the terminal, the power configuration information indicates the power parameter. Once receiving the power configuration information, the terminal can perform the NR service and/or the NR SL service based on the power parameter. Here, the power parameter may be a parameter indicating the maximum transmission power.

In an embodiment of the present disclosure, the network device sends to the terminal indication information indicating the working state. After receiving the indication information, the terminal transmits the NR service and/or the NR SL service based on the working state indicated by the indication information. The network device determines, according to the working state indicated by the indication information, the power parameter for the terminal to transmit the predetermined service. Here, the network device may send to the terminal the indication information indicating the working state through an RRC message.

In an embodiment of the present disclosure, the network device receives the indication information indicating the working state sent by the terminal, and the network device determines, according to the working state indicated by the indication information, the power parameter for the terminal to transmit the predetermined service. Here, the network device may receive, through the RRC message, the indication information indicating the working state sent by the terminal.

In an embodiment of the present disclosure, before sending the power configuration information to the terminal, the network device will configure a first parameter for the terminal, and the first parameter is a power for the terminal to transmit the NR SL service; the network device also configures a second parameter for the terminal, and the second parameter is the maximum transmit power when the terminal transmits the NR service in the cell. Here, the first parameter may be sl-TxPower, and the second parameter may be p-max.

In an embodiment of the present disclosure, the network device determines the working state of the terminal. If the working state of the terminal is determined to be the first working state, a smaller parameter among the first parameter and the second parameter is determined to be the power parameter. For example, if the first parameter is greater than the second parameter, the second parameter is determined to be the power parameter; or, if the first parameter is less than the second parameter, the first parameter is determined to be the power parameter. After the power parameter is determined, the network device sends the power configuration information to the terminal, and the power configuration information indicates the power parameter. It should be noted that the first working state may be a state in which the terminal transmits the NR SL service on the shared spectrum without transmitting the NR service on this shared spectrum. Here, the terminal may perform a single-carrier NR SL service transmission on the shared spectrum.

In an embodiment of the present disclosure, the working state of the terminal is determined. If the working state of the terminal is determined to be the first working state, the power parameter is determined to be the first parameter. After the power parameter is determined, the network device sends the power configuration information to the terminal, and the power configuration information indicates the power parameter.

In an embodiment of the present disclosure, the network device determines the working state of the terminal. If the working state of the terminal is determined to be the second working state, it is necessary to determine a mode in which the terminal transmits the NR service and the NR SL service. According to the determined mode in which the terminal transmits the NR service and the NR SL service, the power parameter for the terminal to transmit the predetermined service is determined. It should be noted that the terminal may transmit the NR service and the NR SL service in a Time Division Multiplexing (TDM) mode, and the terminal may also transmit the NR service and the NR SL service in an FDM mode.

In an embodiment of the present disclosure, if the network device determines that the working state of the terminal is the second working state and determines that the terminal transmits the NR service and the NR SL service in the Time Division Multiplexing (TDM) mode, the network device determines that the power parameter for transmitting the NR service is the second parameter and/or the power parameter for transmitting the NR SL service is the smaller parameter among the configured parameter.

In an embodiment of the present disclosure, if the network device determines that the working state of the terminal is the second working state and determines that the terminal transmits the NR service and the NR SL service in the Frequency Division Multiplexing (FDM) mode, the network device determines that the power parameter for transmitting the NR service is a third parameter and/or the power parameter for transmitting the NR SL service is a fourth parameter, the sum of the third parameter and the fourth parameter is less than the second parameter. Here, the third parameter may be P_{NR}, the fourth parameter may be P_{NR_SL}, and the second parameter may be p-max. It should be noted that in the present disclosure, “less than” has the meaning of “less than or equal to”. It should be noted that here, the terminal transmits the NR service and the NR SL service on different carrier frequencies of the shared spectrum, respectively within the same time.

In an embodiment of the present disclosure, before sending to the terminal the power configuration information for transmitting the predetermined service, the network device will configure a time-frequency domain resource for the terminal according to a service type indicated for the terminal to transmit, and the time-frequency domain resource includes a time domain resource and/or a frequency domain resource. For example, if the service type indicated for the terminal to transmit is the NR SL service, a first time-frequency domain resource will be configured for the terminal; or if the service type indicated for the terminal to transmit is the NR service and the NR SL service, a second time-frequency domain resource for the NR service and a third time-frequency domain resource for the NR SL service will be configured for the terminal. In this way, the working state of the terminal can be determined based on the time-frequency domain resource configured for the terminal. For example, if the time-frequency domain resource configured for the terminal is the first time-frequency domain resource, the working state of the terminal is determined to be the first working state; or, if the time-frequency domain resource configured for the terminal is the second time-frequency domain resource and the third time-frequency domain resource, the working state of the terminal is determined to be the second working state.

In an embodiment of the present disclosure, the terminal is in the first working state, and after receiving the power configuration information, the terminal transmits the NR SL service based on the power parameter indicated by the power configuration information.

In an embodiment of the present disclosure, the terminal is in the second working state, then after receiving the power configuration information, the terminal transmits the NR service and the NR SL service based on the power parameter indicated by the power configuration information. If the terminal transmits the NR service and the NR SL service in the Time Division Multiplexing (TDM) mode, the power parameter for transmitting the NR service is determined to be the second parameter and/or the power parameter for transmitting the NR SL service is determined to be the smaller parameter among the configured parameters. Alternatively, if the terminal transmits the NR service and the NR SL service in the Frequency Division Multiplexing (FDM) mode, the power parameter for transmitting the NR service is determined to be the third parameter and/or the power parameter for transmitting the NR SL service is determined to be the fourth parameter. The sum of the third parameter and the fourth parameter is less than the second parameter. It should be noted that the configured parameter, the third parameter and the fourth parameter have been described above, which will not be repeated here.

It should be noted that those skilled in the art can understand that the method provided in embodiments of the present disclosure can be executed alone or in combination with some methods in the embodiments of the present disclosure or some methods in the related arts.

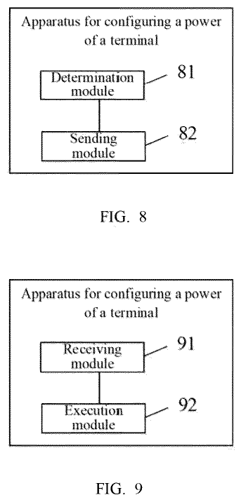

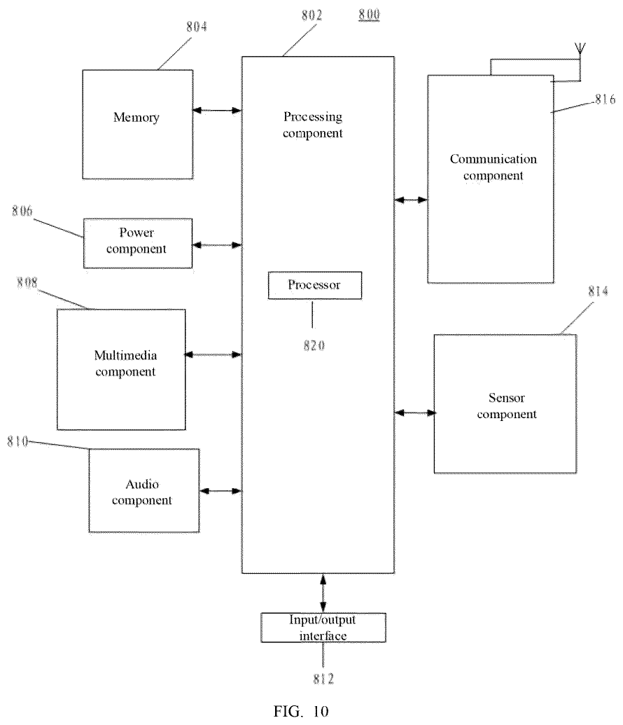

As shown in FIG. 8, an embodiment of the present disclosure provides an apparatus for configuring a power of a terminal, and the apparatus includes:
a determination module 81, configured to determine, according to a working state of the terminal, a power parameter for the terminal to transmit a predetermined service;
the predetermined service includes: a New Radio (NR) service and/or an NR Sidelink (SL) service; and the working state includes one of:
a first working state indicating a state in which the NR SL service is transmitted by the terminal on a shared spectrum; or
a second working state indicating a state in which the NR service and the NR SL service are transmitted by the terminal on the shared spectrum.

In an embodiment of the present disclosure, the determination module 81 is further configured to:
determine, according to the working state of the terminal, the power parameter based on a configured parameter;
the configured parameter includes at least one of:
a first parameter, which is a power for the terminal to transmit the NR SL service; or
a second parameter, which is a maximum transmit power of the terminal when transmitting the NR service in a cell.

In an embodiment of the present disclosure, the determination module 81 is further configured to:
in response to the terminal being in the first working state, determine the power parameter to be a smaller parameter among the configured parameter.

In an embodiment of the present disclosure, the determination module 81 is further configured to:
in response to the terminal being in the first working state, determine the power parameter to be the first parameter.

In an embodiment of the present disclosure, the determination module 81 is further configured to:
in response to the terminal being in the second working state and transmitting the NR service and the NR SL service in a Time Division Multiplexing (TDM) mode, determine the power parameter for transmitting the NR service to be the second parameter and/or determine the power parameter for transmitting the NR SL service to be a smaller parameter among the configured parameter.

In an embodiment of the present disclosure, the determination module 81 is further configured to:
in response to the terminal being in the second working state and transmitting the NR service and the NR SL service in a Frequency Division Multiplexing (FDM) mode, determine the power parameter for transmitting the NR service to be a third parameter and/or determine the power parameter for transmitting the NR SL service to be a fourth parameter, and a sum of the third parameter and the fourth parameter is less than the second parameter.

In an embodiment of the present disclosure, the determination module 81 is further configured to:
determine the working state of the terminal according to a time-frequency domain resource configured for the terminal;
the time-frequency domain resource includes a time domain resource and/or a frequency domain resource.

In an embodiment of the present disclosure, the apparatus further includes:
a sending module 82, configured to send to the terminal power configuration information for transmitting the predetermined service; and
the power configuration information indicates the power parameter.

It should be noted that those skilled in the art can understand that the method provided in embodiments of the present disclosure can be executed alone or in combination with some methods in the embodiments of the present disclosure or some methods in the related arts.

As shown in FIG. 9, an embodiment of the present disclosure provides an apparatus for configuring a power of a terminal, and the apparatus includes:
a receiving module 91, configured to receive power configuration information for transmitting a predetermined service, the predetermined service includes: a NR service and/or a NR SL service, and the power configuration information indicates a power parameter; and
an execution module 92, configured to transmit the NR service and/or the NR SL service based on the power parameter.

It should be noted that those skilled in the art can understand that the method provided in embodiments of the present disclosure can be executed alone or in combination with some methods in the embodiments of the present disclosure or some methods in the related arts.

An embodiment of the present disclosure provides a communication device, and the communication device includes:
a processor; and
a memory configured to store executable instructions of the processor;
the processor is configured to implement the method described in any embodiment of the present disclosure when running the executable instructions.

The processor may include various types of storage media, which are non-transitory computer storage media that can continue to memorize information stored thereon after the communication device loses power.

The processor may be connected to the memory via a bus or the like to read the executable program stored in the memory.

An embodiment of the present disclosure further provides a computer storage medium having a computer executable program stored thereon, which, when executed by a processor, implement the method described in any embodiment of the present disclosure.

Regarding the apparatus in the above embodiments, a specific manner in which each module performs operations has been described in detail in the method embodiments, which will not be elaborated here.

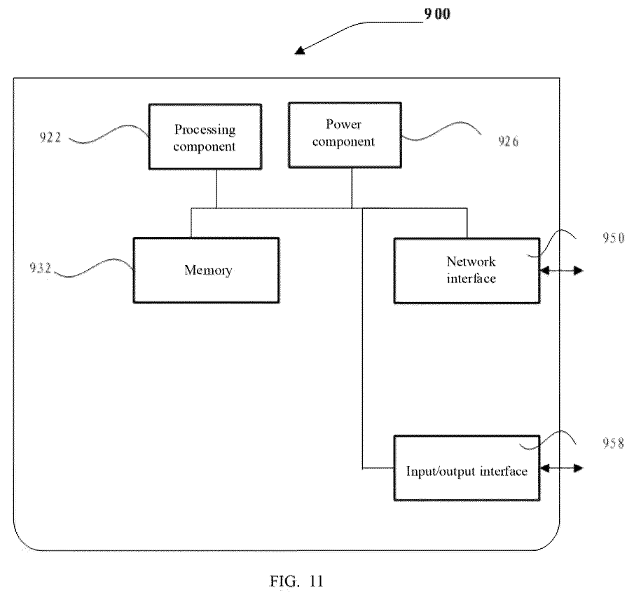

As shown in FIG. 10, an embodiment of the present disclosure provides a structure of a terminal.

Referring to a terminal 800 shown in FIG. 10, this embodiment provides the terminal 800, which may be specifically a mobile phone, a computer, a digital broadcast terminal, a messaging device, a gaming console, a tablet device, a medical device, an exercise device, a personal digital assistant, etc.

Referring to FIG. 10, the terminal 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the terminal 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the terminal 800. Examples of such data include instructions for any applications or methods operated on the terminal 800, contact data, phonebook data, messages, pictures, video, etc. The memory 804 may be implemented using any type of volatile or non-volatile memory apparatuses, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the terminal 800. The power component 806 may include a power management system, one or more power sources, and any other components associated with the generation, management, and distribution of power in the terminal 800.

The multimedia component 808 includes a screen providing an output interface between the terminal 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a duration and a pressure associated with the touch or swipe action. In some embodiments, the multimedia component 808 includes a front camera and/or a rear camera. The front camera and the rear camera may receive an external multimedia datum while the terminal 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (MIC) configured to receive an external audio signal when the terminal 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide state assessments of various aspects of the terminal 800. For instance, the sensor component 814 may detect an open/closed state of the terminal 800, relative positioning of components, e.g., the display and the keypad, of the terminal 800, a change in position of the terminal 800 or a component of the terminal 800, a presence or absence of user contact with the terminal 800, an orientation or an acceleration/deceleration of the terminal 800, and a change in temperature of the terminal 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the terminal 800 and other devices. The terminal 800 may access a wireless network based on a communication standard, such as WiFi, 2G, or 3G, or a combination thereof. In an embodiment, the communication component 816 receives a broadcast signal or broadcast associated information from an external broadcast management system via a broadcast channel. In an embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment of the present disclosure, the terminal 800 may be implemented with one or more application specific integrated circuits (ASICs), digital signal processors (DSPs), digital signal processing devices (DSPDs), programmable logic devices (PLDs), field programmable gate arrays (FPGAs), controller, micro-controller, microprocessors, or other electronic components, for performing the above described methods.

In an embodiment of the present disclosure, there is further provided a non-transitory computer readable storage medium including instructions, such as the memory 804 including instructions, the above instructions may be executed by the processor 820 in the terminal 800 for performing the above-described methods. For example, the non-transitory computer-readable storage medium may be a ROM, a Random Access Memory (RAM), a CD-ROM, a magnetic tape, a floppy disc, an optical data storage device, and the like.

As shown in FIG. 11, an embodiment of the present disclosure provides a structure of a base station. For example, a base station 900 may be provided as a network side device. Referring to FIG. 11, the base station 900 includes a processing component 911, which further includes one or more processors and a memory resource represented by a memory 932 for storing instructions executable by the processing component 922, such as an application program. The application program stored in the memory 932 may include one or more modules, each corresponding to a set of instructions. In addition, the processing component 922 is configured to execute the instructions to execute the aforementioned any method applied on the base station.

The base station 900 may further include: a power component 926 configured to perform power management of the base station 900, a wired or wireless network interface 950 configured to connect the base station 900 to the network, and an input/output (I/O) interface 958. The base station 900 may operate an operating system stored in the memory 932, such as Windows Server™, Mac OS X™, Unix™, Linux™, FreeBSD™, or the like.

Embodiments of the present disclosure provide a method and apparatus for configuring a power of a terminal, a communication device and a storage medium.

According to a first aspect of embodiments of the present disclosure, there is provided a method for configuring a power of a terminal, wherein the method is performed by a network device, and includes:
determining, according to a working state of the terminal, a power parameter for the terminal to transmit a predetermined service;
wherein the predetermined service includes: a New Radio (NR) service and/or an NR Sidelink (SL) service; and the working state includes one of:
a first working state indicating a state in which the NR SL service is transmitted by the terminal on a shared spectrum; or
a second working state indicating a state in which the NR service and the NR SL service are transmitted by the terminal on the shared spectrum.

In an embodiment of the present disclosure, the determining, according to the working state of the terminal, the power parameter of the terminal includes:
determining, according to the working state of the terminal, the power parameter based on a configured parameter;
wherein the configured parameter includes at least one of:
a first parameter, which is a power for the terminal to transmit the NR SL service; or
a second parameter, which is a maximum transmit power of the terminal when transmitting the NR service in a cell.

In an embodiment of the present disclosure, the determining, according to the working state of the terminal, the power parameter based on the configured parameter includes:
in response to the terminal being in the first working state, determining the power parameter to be a smaller parameter among the configured parameter.

In an embodiment of the present disclosure, the determining, according to the working state of the terminal, the power parameter based on the configured parameter includes:
in response to the terminal being in the first working state, determining the power parameter to be the first parameter.

In an embodiment of the present disclosure, the determining, according to the working state of the terminal, the power parameter based on the configured parameter includes:
in response to the terminal being in the second working state and transmitting the NR service and the NR SL service in a Time Division Multiplexing (TDM) mode, determining the power parameter for transmitting the NR service to be the second parameter and/or determining the power parameter for transmitting the NR SL service to be a smaller parameter among the configured parameter.

In an embodiment of the present disclosure, the determining, according to the working state of the terminal, the power parameter based on the configured parameter includes:
in response to the terminal being in the second working state and transmitting the NR service and the NR SL service in a Frequency Division Multiplexing (FDM) mode, determining the power parameter for transmitting the NR service to be a third parameter and/or determining the power parameter for transmitting the NR SL service to be a fourth parameter, wherein a sum of the third parameter and the fourth parameter is less than the second parameter.

In an embodiment of the present disclosure, the method further includes:
determining the working state of the terminal according to a time-frequency domain resource configured for the terminal;
wherein the time-frequency domain resource includes a time domain resource and/or a frequency domain resource.

In an embodiment of the present disclosure, the method further includes:
sending to the terminal power configuration information for transmitting the predetermined service;
wherein the power configuration information indicates the power parameter.

According to a second aspect of embodiments of the present disclosure, there is provided a method for configuring a power of a terminal, wherein the method is performed by the terminal, and includes:
receiving power configuration information for transmitting a predetermined service, wherein the predetermined service includes: a NR service and/or a NR SL service, and the power configuration information indicates a power parameter; and
transmitting the NR service and/or the NR SL service based on the power parameter.

According to a third aspect of embodiments of the present disclosure, there is provided an apparatus for configuring a power of a terminal, wherein the apparatus includes:
a determination module, configured to determine, according to a working state of the terminal, a power parameter for the terminal to transmit a predetermined service;
wherein the predetermined service includes: a New Radio (NR) service and/or an NR Sidelink (SL) service; and the working state includes one of:
a first working state indicating a state in which the NR SL service is transmitted by the terminal on a shared spectrum; or
a second working state indicating a state in which the NR service and the NR SL service are transmitted by the terminal on the shared spectrum.

In an embodiment of the present disclosure, the determination module is further configured to:
determine, according to the working state of the terminal, the power parameter based on a configured parameter;
wherein the configured parameter includes at least one of:
a first parameter, which is a power for the terminal to transmit the NR SL service; or
a second parameter, which is a maximum transmit power of the terminal when transmitting the NR service in a cell.

In an embodiment of the present disclosure, the determination module is further configured to:
in response to the terminal being in the first working state, determine the power parameter to be a smaller parameter among the configured parameter.

In an embodiment of the present disclosure, the determination module is further configured to:
in response to the terminal being in the first working state, determine the power parameter to be the first parameter.

In an embodiment of the present disclosure, the determination module is further configured to:
in response to the terminal being in the second working state and transmitting the NR service and the NR SL service in a Time Division Multiplexing (TDM) mode, determine the power parameter for transmitting the NR service to be the second parameter and/or determine the power parameter for transmitting the NR SL service to be a smaller parameter among the configured parameter.

In an embodiment of the present disclosure, the determination module is further configured to:
in response to the terminal being in the second working state and transmitting the NR service and the NR SL service in a Frequency Division Multiplexing (FDM) mode, determine the power parameter for transmitting the NR service to be a third parameter and/or determine the power parameter for transmitting the NR SL service to be a fourth parameter, wherein a sum of the third parameter and the fourth parameter is less than the second parameter.

In an embodiment of the present disclosure, the determination module is further configured to:
determine the working state of the terminal according to a time-frequency domain resource configured for the terminal;
wherein the time-frequency domain resource includes a time domain resource and/or a frequency domain resource.

In an embodiment of the present disclosure, the apparatus further includes:
a sending module, configured to send to the terminal power configuration information for transmitting the predetermined service;
wherein the power configuration information indicates the power parameter.

According to a fourth aspect of embodiments of the present disclosure, there is provided an apparatus for configuring a power of a terminal, wherein the apparatus includes:
a receiving module, configured to receive power configuration information for transmitting a predetermined service, wherein the predetermined service includes: a NR service and/or a NR SL service, and the power configuration information indicates a power parameter; and
an execution module, configured to transmit the NR service and/or the NR SL service based on the power parameter.

According to a fifth aspect of embodiments of the present disclosure, there is provided a communication device, including:
a processor; and
a memory configured to store executable instructions of the processor;
wherein the processor is configured to implement the method described in any embodiment of the present disclosure when running the executable instructions.

According to a sixth aspect of embodiments of the present disclosure, there is provided a computer storage medium having a computer executable program stored thereon, which, when executed by a processor, implement the method described in any embodiment of the present disclosure.

Other implementations of the present disclosure will be apparent to those skilled in the art from consideration of the specification and practice of the present disclosure disclosed here. The present disclosure is intended to cover any variations, uses, or adaptations of the present disclosure following the general principles thereof and including the common general knowledge or habitual technical means in the technical field not disclosed in the present disclosure. The specification and embodiments are considered as exemplary only, and a true scope and spirit of the present disclosure is indicated by the appending claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A method for configuring a power of a terminal, performed by a network device, the method comprising:
determining, according to a working state of the terminal, a power parameter for the terminal to transmit a predetermined service,
wherein the predetermined service includes at least one of a New Radio (NR) service or an NR Sidelink (SL) service, and
the working state includes one of:
a first working state indicating a state in which the NR SL service is transmitted by the terminal on a shared spectrum; or
a second working state indicating a state in which the NR service and the NR SL service are transmitted by the terminal on the shared spectrum.

2. The method according to claim 1, wherein determining, according to the working state of the terminal, the power parameter includes:
determining, according to the working state of the terminal, the power parameter based on a configured parameter,
wherein the configured parameter includes at least one of:
a first parameter, which is a power for the terminal to transmit the NR SL service; or
a second parameter, which is a maximum transmit power of the terminal when transmitting the NR service in a cell.

3. The method according to claim 2, wherein determining, according to the working state of the terminal, the power parameter based on the configured parameter includes:
in response to the terminal being in the first working state, determining the power parameter to be a smaller parameter among the configured parameter.

4. The method according to claim 2, wherein determining, according to the working state of the terminal, the power parameter based on the configured parameter includes:
in response to the terminal being in the first working state, determining the power parameter to be the first parameter.

5. The method according to claim 2, wherein determining, according to the working state of the terminal, the power parameter based on the configured parameter includes:
in response to the terminal being in the second working state and transmitting the NR service and the NR SL service in a Time Division Multiplexing (TDM) mode, determining the power parameter for transmitting the NR service to be the second parameter and/or determining the power parameter for transmitting the NR SL service to be a smaller parameter among the configured parameter.

6. The method according to claim 2, wherein determining, according to the working state of the terminal, the power parameter based on the configured parameter includes:
in response to the terminal being in the second working state and transmitting the NR service and the NR SL service in a Frequency Division Multiplexing (FDM) mode, determining the power parameter for transmitting the NR service to be a third parameter and/or determining the power parameter for transmitting the NR SL service to be a fourth parameter, wherein a sum of the third parameter and the fourth parameter is less than the second parameter.

7. The method according to claim 1, further comprising:
determining the working state of the terminal according to a time-frequency domain resource configured for the terminal,
wherein the time-frequency domain resource includes at least one of a time domain resource or a frequency domain resource.

8. The method according to claim 1, further comprising:
sending to the terminal power configuration information for transmitting the predetermined service,
wherein the power configuration information indicates the power parameter.

9. A method for configuring a power of a terminal, performed by the terminal, the method comprising:
receiving power configuration information for transmitting a predetermined service, wherein the predetermined service includes at least one of a New Radio (NR) service or an NR Sidelink (SL) service, and wherein the power configuration information indicates a power parameter; and
transmitting the at least one of the NR service or the NR SL service based on the power parameter.

10-18. (canceled)

19. A communication device, comprising:
a processor; and
a memory storing instructions executable by the processor, and
wherein the processor is configured to:
determine, according to a working state of the terminal, a power parameter for the terminal to transmit a predetermined service,
wherein the predetermined service includes at least one of a New Radio (NR) service or an NR Sidelink (SL) service, and
the working state includes one of:
a first working state indicating a state in which the NR SL service is transmitted by the terminal on a shared spectrum; or
a second working state indicating a state in which the NR service and the NR SL service are transmitted by the terminal on the shared spectrum.

20. A non-transitory computer-readable storage medium having computer executable instructions stored thereon, which, when executed by a processor, are configured to perform the method according to claim 1.

21. The communication device according to claim 19, wherein the processor is further configured to:
determine, according to the working state of the terminal, the power parameter based on a configured parameter,
wherein the configured parameter includes at least one of:
a first parameter, which is a power for the terminal to transmit the NR SL service; or
a second parameter, which is a maximum transmit power of the terminal when transmitting the NR service in a cell.

22. The communication device according to claim 21, wherein the processor is further configured to:
in response to the terminal being in the first working state, determine the power parameter to be a smaller parameter among the configured parameter.

23. The communication device according to claim 21, wherein the processor is further configured to:
in response to the terminal being in the first working state, determine the power parameter to be the first parameter.

24. The communication device according to claim 21, wherein the processor is further configured to:
in response to the terminal being in the second working state and transmitting the NR service and the NR SL service in a Time Division Multiplexing (TDM) mode, determine the power parameter for transmitting the NR service to be the second parameter and/or determine the power parameter for transmitting the NR SL service to be a smaller parameter among the configured parameter.

25. The communication device according to claim 21, wherein the processor is further configured to:
in response to the terminal being in the second working state and transmitting the NR service and the NR SL service in a Frequency Division Multiplexing (FDM) mode, determine the power parameter for transmitting the NR service to be a third parameter and/or determine the power parameter for transmitting the NR SL service to be a fourth parameter, wherein a sum of the third parameter and the fourth parameter is less than the second parameter.

26. The communication device according to claim 19, wherein the processor is further configured to:
determine the working state of the terminal according to a time-frequency domain resource configured for the terminal,
wherein the time-frequency domain resource includes at least one of a time domain resource or a frequency domain resource.

27. The communication device according to claim 19, wherein the processor is further configured to:
send to the terminal power configuration information for transmitting the predetermined service,
wherein the power configuration information indicates the power parameter.

28. A communication device, comprising:
a processor; and
a memory storing instructions executable by the processor,
wherein the processor is configured to perform the method according to claim 9.

29. A non-transitory computer-readable storage medium having computer executable instructions stored thereon, which, when executed by a processor, are configured to perform the method according to claim 9.
